(19) United States
(12) Patent Application Publication
(10) Pub. No.: US 2007/0088920 A1
(43) Pub. Date: Apr. 19, 2007

(54) Managing data for memory, a data store, and a storage device

(76) Inventors: Philip Garcia, Cupertino, CA (US); Vedran Degoricija, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/254,470

(22) Filed: Oct. 19, 2005

(51) Int. Cl. G06F 13/00

(52) U.S. Cl. 711/154

(57) ABSTRACT

Embodiments of the invention relate to managing data in computer systems. In an embodiment, an “intermediate” page store is created between main memory and a storage disc. As data is about to be paged out of main memory, a paging manager determines if the data should be sent to the intermediate page store or directly to the disc. Various factors are considered by the paging manager including, for example, current compressibility of the data, previous history of compressibility, current need for quick access of the data, previous history of need for quick access, etc. Because the data stored in the page store may be compressed and accessing the page store is much faster than accessing the storage disc, the paging system can page data significantly faster than from the disc alone without giving up much physical memory that constitutes the page store.

### BACKGROUND OF THE INVENTION

Paging refers to a technique used by virtual memory systems to emulate more physical main memory than is actually present. The operating system, generally via a paging manager, swaps data pages between main memory and a storage device wherein main memory is generally much faster than the storage device. When a program application desires data in a page that is not in main memory, but, e.g., in the storage device, the operating system brings the desired page into memory and swaps another page in main memory to the storage device.

Most current paging mechanisms page data directly to/from disc drives. If the data is missed in main memory, then it requires a paging operation to very slow disc drives. Further, the paging operation may not be optimal because the data is swapped back and forth between memory and the disc drives in an inflexible manner with limited ability to learn and adapt over time.

### SUMMARY OF THE INVENTION

Embodiments of the invention relate to managing data in computer systems. In an embodiment, an “intermediate” page store is created between main memory and a storage disc. As data is about to be paged out of main memory, a paging manager determines if the data should be sent to the intermediate page store or directly to the disc. Various factors are considered by the paging manager including, for example, current compressibility of the data, previous history of compressibility, current need for quick access of the data, previous history of need for quick access, etc. Because the data stored in the page store may be compressed and accessing the page store is much faster than accessing the storage disc, the paging system can page data significantly faster than from the disc alone without giving up much physical memory that constitutes the page store. Other embodiments are also disclosed.

### BRIEF DESCRIPTION OF THE DRAWINGS

The present invention is illustrated by way of example, and not by way of limitation, in the figures of the accompanying drawings in which like reference numerals refer to similar elements and in which:

FIG. 1 shows an arrangement upon which embodiments of the invention may be implemented.

### DETAILED DESCRIPTION OF VARIOUS EMBODIMENTS

In the following description, for the purposes of explanation, numerous specific details are set forth in order to provide a thorough understanding of the present invention. However, it will be apparent to one skilled in the art that the invention may be practiced without these specific details. In other instances, well-known structures and devices are shown in block diagram form in order to avoid obscuring the invention.

### Overview

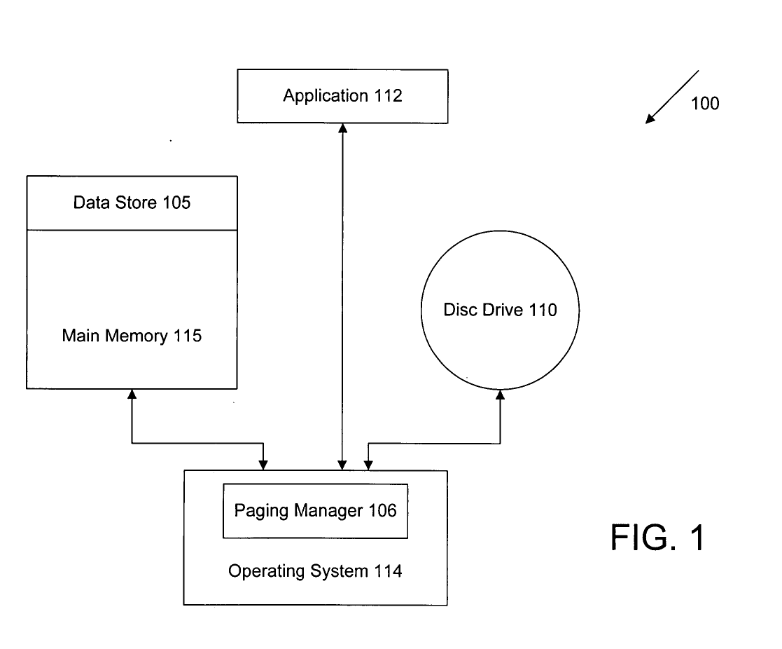

FIG. 1 shows an arrangement 100 upon which embodiments of the invention may be implemented. Data store 105 is created “between” system memory, e.g., main or physical memory 115, and storage disc, e.g., disc drive, 110. In an embodiment, data store 105 resides in a reserved portion of main memory 115, but other convenient locations are within scope of embodiments of the invention. Data store 105 may be referred to as a page store because, in various embodiments, data is transferred in and out of data store 105 in a page unit, which varies, and maybe, for example, 4 Kb, 8 Kb, 16 Kb, etc. Page store 105 stores paged data in accordance with techniques of embodiments of the invention. Since data in page store 105 may be compressed in various embodiments, page store 105 may store much more data than its capacity. For example, if page store 105 is 0.6 GB, and if the compression factor is 4-to-1, then page store 105 can store 2.4 GB (0.6 GB X 4) worth of data. The size of page store 105 is adaptive or varies dynamically. That is, page store 105 may grow or shrink as desired. For example, at a particular point in time, page store 105 may have a size of 0 GB if the data does not compress well and quick access is not desired, and the data is therefore not transferred to page store 105, but is paged out directly to hard disc 110. At some other time, page store 105 may have a size of 0.25 GB if the data compresses well and quick access is desirable, and 0.25 GB is an appropriate size that can efficiently store the data. At yet some other time, page store 105 might have a size of 0.5 GB if the data compresses very well and very quick access is desirable or if paging manger 106 predicts that this will soon be the case. The size of page store 105 may also vary continuously. For illustration purposes, main memory 115 is 2.0 G, and, in the above example, if the size of page store 105 is 0.6 GB and the data compresses by a factor of 4×, then physical memory is 1.4 GB, and the 0.6 GB of page store 105 is for paging operations and actually encompasses 2.4 GB (4×0.6 GB), which is of additional fast memory, instead of slow disk access, in addition to the 1.4 GB of usable main memory. Accessing data from page store 105 (and main memory 115) is much faster than disc drive 110. The size of page store 105 increases each time there is additional data to be stored in page store 105, such as, 1) after a memory allocation request that causes memory in main memory 115 to be allocated, which in turn causes the previous data in main memory 115 to be paged out of main memory 115 into page store 105 and/or disc drive 110, or 2) after a page miss that causes data to be paged in from disc drive 110 and/or page store 105 and previous data in main memory 115 to be paged out of main memory 115 into page store 105 and/or disc drive 110. Memory allocation is commonly referred to as “malloc,” because memory is allocated using a “malloc” function call. A page miss occurs when data in page store 105 or disc drive 110 is not in main memory 115 upon accessing main memory 115. Once the size of page store 105 reaches its maximum limit, the to-be-paged-out data is paged to disc drive 110 or some data in page store 105 is evicted to provide the space for this to-be-paged-out data. In various embodiments of the invention, moving data between main memory 115 and page store 105 is done by redirecting the pointer to the data. As a result, the physical data does not move, but the pointer to the data moves.

Paging manager 106 is commonly found in an operating system of computer systems. However, paging manager 106 is modified to implement techniques in accordance with embodiments of the invention. Paging manager 106 may be an independent entity or may be part of another entity, e.g., a software package, a memory manager, a memory controller, etc., and embodiments of the invention are not limited to how a paging manager is implemented. In an embodiment, as data is about to be paged out of main memory 115, paging manager 106 determines if the data should be sent to page store 105 or to disc drive 110 or both. If being sent to page store 105, then the data may be compressed or non-compressed. The compression algorithm (e.g., “effort”) can also vary. Data compression may be done by hardware, software, a combination of both hardware and software, etc., and the invention is not limited to a method of compression. Paging manager 106, having appropriate information or “hints” that are associated with a page when the page is first allocated, e.g., by a malloc request, determines whether the data is a good fit for page store 105. For example, paging manager 106, based on hints, history, etc., determines whether the data should be compressed and/or be stored in page store 105 or should not be compressed and sent directly to disc drive 110. Paging manager 106 also determines the compression effort and/or algorithm. In determining when to compress, how much compression, and where to page out data, etc., paging manager 106 uses various considerations, including, for example, current compressibility of the data, previous history of compressibility, current need for quick access of the data, previous history of need for quick access, etc. If quick data access is desirable and/or data compressibility is high, then the data is transferred to page store 105, instead of disc drive 110. In various embodiments, hints for paging manager 106's determination are provided by processes/applications that own the data when the page for the data is allocated because those applications would have a good notion of how quickly the data may need to be accessed again or how well the data might compress. As such, paging manager 106 keeps records of how often certain data is accessed. Paging manager 106 also determines the nature of the data usage, e.g., whether it's real-time or not. If the operating system is real-time, then, generally, it is desirable to have quicker access to the data than in a non-real-time operating system. As a result, there are situations in which even if the data does not compress very well, but the operating system is real-time, then there is more incentive to have the data stored in page store 105. Further, the size of page store 105 grows and shrinks as the various conditions dictate and as paging manager 106 learns about the data, the nature of the operating system, the applications, etc. Paging manager 106 may also use knowledge of history to make decisions. For example, for some recent period, e.g., 15 ms, if data from an application has not compressed very well, then chances are that it will not compress well now, and therefore should be sent directly to hard disc 110, instead of to page store 105. Conversely, e.g., if, in the past 15 ms, data has been compressed very well, then chances are that it will continue to compress well and thus is a good candidate for page store 105, etc. As another example, if paging manager 106 has statistics that in a recent period of 15 ms, data was on average compressed by a factor of 2-to-1, then data that is compressed better than 2-to-1, e.g., 4-to-1, will be stored in page store 105 while data that is compressed worse than 2-to-1 will be paged out to hard disc 110, etc. For another example, if the compression ratio of the data to be paged out is 10-to-1, but the compression ratio of the data currently in page store 105 is better than 10-to-1, e.g., 20-to-1, then the data-to-be-paged-out would be paged to disc drive 110. However, if the compression ratio of the data currently in page store 105 is worse than 10-to-1, e.g., 2-to-1, then the 2-to-1 data would be evicted to provide room for the 10-to-1 data.

Alternatively, if hints are not available, then paging manager 106 determines by itself how well the data compresses. In an embodiment, paging manager 106 has the data compressed, and, based on the results, makes decisions. For example, if the result indicates high compressibility, then the data is a good candidate for page store 105. Conversely, if the result indicates low/non compressibility, then the data should be paged directly to disc drive 110, etc.

In an embodiment, when data is about to be paged out of memory 115, the data is both sent to disc drive 110 and compressed as if it would be stored in page store 105. If it turns out that the data is not a good candidate for page store 105, e.g., because of a low compressibility ratio, then the data would be discarded out of page store 105, which, in an embodiment, is marked as invalid. Alternatively, the data is discarded by being moved to disc drive 110, and, in a compressed manner, if the data has been compressed, so that it can later be pre-paged back into the page store 105 without being re-compressed.

Disc drive 110, also commonly found in computer systems, stores data that is swapped out of main memory 115, if such data is not to be stored in page store 105. If the data is a good fit in page store 105, then it is sent there without being brought to disc drive 110. Disc drive 110 is used as an example, other storage devices appropriate for swapped data are within scope of embodiments of the invention.

Program application 112 provides hints for paging manager 106 to decide whether to compress the data, to bypass page store 105 and thus transfer the data directly to disc drive 110, etc. Depending on situations, application 112 may provide hints as to how much the data should be compressed, including, for example, low, medium, high compressibility, etc., how fast the data needs to be accessed, e.g., low, medium, high accessibility, etc. For example, low, medium, and high compressibility correspond to a compression ratio of 2-to-1, 3-to-1, and 4-to-1, respectively. Low, medium, high, etc., are provided as examples only, different degrees of compression factors and/or different methods for providing hints are within scope of embodiments of the invention. In an embodiment, hints are provided to the operating system and/or paging manager 106 when application 112 requests a memory allocation, such as using a “malloc” function call. When appropriate, e.g., when there is a desire to swap data, paging manager 106 and/or operating system 114 will use such hints. In an embodiment, parameters passed to the malloc function are reserved for providing the hints, e.g., one field for compressibility, one field for access time, etc. However, other ways to provide such hints are within scope of embodiments of the invention. As a result, operating system 114/paging manager 106 is configured to recognize such hints in order to act accordingly. Generally, application 112 including its related processes has good knowledge as to how data compresses, how quickly a piece of data would be desired and thus accessed, etc. For example, a process that is manipulating video streams would know that the data streams would not compress well because, in general, video has been compressed already. In contrast, a Word document with ASCII text would be highly compressible. Similarly, a Word document having both ASCII and image would have medium compressibility, etc. As another example, a text editor generally does not desire very fast access because there is no desire to instantly bring up the data to the display. However, an application with a real-time motor controller would desire to access the data quickly because of a desire for a quick response. Depending on situations, access time may be based on priority of data, which in turn, may be configured by a programmer, a system administrator, etc.

Operating system 114, via appropriate entities, such as paging manager 106, having the information, may decide to compress the data, store it in page store 105, directly transfer the data to hard disc 110, etc. Operating system 114 is commonly found in computer systems and is retooled to implement techniques in accordance with embodiments of the invention. For example, where a parameter in the malloc function is used to provide hints to operating system 114, operating system 114 is configured to recognize such parameter and thus such hints.

### Illustration of an Application

Following is an illustration of how an embodiment of the invention is used. For illustration purposes, application 112 is running a notepad file with unformatted data based on which application 112 recognizes that the data will compress well. Application 112 then desires memory for the notepad file and thus requests memory by a malloc function call. Application 112, recognizing that the notepad file will compress well, fills in the hint field of one of the malloc parameters with “high compressibility.”

Application 112 is going to request four 16 Kb pages for a total of 64 Kb of memory which application 112 will obtain from a memory manager (not shown) regardless of compressibility. Additionally, high compressibility indicates a 4×compression. That is, 64 Kb of 4 pages of data, after compression, requires only 16 Kb or one page of storage space in page store 105. In order for four pages of memory to be allocated in main memory 115 for application 112, at least four different pages are to be paged out of main memory 115 to either page store 105 and/or disc drive 110. Depending on situations, various considerations are used for the page out, such as, what was least recently used (LRU), compressibility, need for quick access, etc.

Later another application either 1) malloc's additional memory from main memory 115 or 2) accesses its previously paged out data residing in page store 105 or disc drive 110, which results in paging back into main memory 115 that data. In order to make room for the other application's new data in main memory 115, pages from main memory 115 are evicted to page store 105 and/or disc drive 110. For illustration purposes, the pages to now be paged out/evicted have been chosen to be the four pages owned by the notepad application.

Paging manager 106, recognizing the “high compressibility” option, determines that the data is a good candidate for page store 105. For illustration purposes, at this time, the size of page store 105 is OMB even though some other sizes are within scope of embodiments of the invention.

Paging manager 106, recognizing the size request of 64 Kb and the “high compressibility” option, compresses the 64 Kb, discovers that the compressed size is, for example, 15 Kb, which fits within one 16 Kb page, and thus creates 16 Kb of space in page store 105. Creating 16 Kb in page store 105 is transparent to application 112. That is, application 112 does not know that only 16 Kb is created for the paged out data. In fact, application 112 does not know that the data has been paged out.

At this point, four pages of 64 Kb have been evicted/paged out of main memory 115 so that there are four pages of free space in main memory 115. Since the corresponding one page of 16 Kb of compressed data is being inserted into page store 105, and since in the embodiment of FIG. 1, page store 105 is part of main memory 115, main memory 115 is reduced by one page of 16 Kb. The result is that page store 105 increases by one page, main memory 115 decreases by the same amount of one page, and the amount of space freed in main memory 115 becomes three pages, That is, the four pages evicted minus the one page of space reassigned from main memory 115 to page store 105. The three free pages in main memory 115 are available for the malloc or the paging in operations which initiated these paging out operations.

Eventually, when application 112 tries to access its 64 Kb (four pages) of memory, which is no longer in main memory 115, a page fault occurs which triggers paging operations. Paging manager 106 is able to quickly retrieve the corresponding compressed page in page store 105, instead of from a very slow disk read from disc drive 110, and uncompress it back into four pages in main memory 115. Since page store 105 decreases by one page, main memory 115 increases by one free page which is used for one of the four pages to be paged in. At least three more pages will be freed (paged out) to accommodate the paging in operation. If there is no good candidate for paging out to page store 105, then three pages are paged out to disc drivel 10. If there is a good candidate for paging out to page store 105 (perhaps data that will likely compress better than by a 4:1 ratio), then more than three pages will be paged out since page store 105 will increase and main memory 115 will decrease by the compressed amount.

As data is paged out of main memory 115 to page store 105, paging manager 106 re-evaluates the composition of page store 105. It may determine that some compressed pages were not compressed as highly as all the more recent pages or that some compressed pages are the least recently used pages. These could then be evicted to disc drive 110, which results in page store 105 decreasing and consequently main memory 115 growing.

Paging manager 106 may choose to pre-page data from disc drive 110 to page store 105. One such scenario might be, for example, when an idle application enters the running state but has not yet accessed data it owns. Since the application is likely soon to do so, paging manager 106 may anticipate this and pre-page in advance that data from disk drive 110 to page store 105. Since the data will be compressed in page store 105, the cost in terms of memory consumption is small if the guess is incorrect, which allows for more aggressive pre-paging.

Finally, paging manager 106 is able to measure paging and memory performance via conventional means as well as by the ratio of page store hits to page store hits plus misses. Based upon these measures paging manager 106 is able to learn and adapt. It may choose to more or less aggressively fill or empty page store 105. It may decide to shift priorities between most compressible, need for quick access, least recently used, etc. It may decide to more or less aggressively compress data. It may decide to more or less aggressively pre-page from disk drive 110 to page store 105. In effect, the intermediate page store 105 adapts based upon performance considerations.

Furthermore, a system administrator with knowledge of the computer's workload may manually configure paging manager 106. This allows for manually setting a constant page store size, priorities for filling it, compression effort, etc. This would be advantageous when the computer serves a dedicated purpose.

### Advantages

Embodiments of the invention are advantageous over other approaches for various reasons including, for example, fast intermediate page store that reduces the need to access slow disk drives, ability to adjust size of page store, to bypass page store, to change compression effort of individual pages, etc. The paging scheme/algorithm can determine when it is appropriate to use page store 105 and have it grow or shrink or bypass it, etc. Because the size of page store 105 is adapted or configurable depending on the data stream, e.g., embodiments of the invention may be referred to as “adaptive.” A system in accordance with embodiments appears to have less physical main memory 115 than it actually has but can page data in and out of main memory 115 faster than from disc drives. Decompression of compressed data is substantially faster than having to access a slow disc drive. As a result, memory paging and/or system performance is improved.

### Computer

A computer may be used to run application 112, to perform embodiments in accordance with the techniques described in this document, etc. For example, a CPU (Central Processing Unit) of the computer executes program instructions implementing the method embodiments by loading the program from a CD-ROM (Compact Disc-Read Only Memory) to RAM (Random Access Memory) and executes those instructions from RAM. The program may be software, firmware, or a combination of software and firmware. In alternative embodiments, hard-wire circuitry may be used in place of or in combination with program instructions to implement the described techniques. Consequently, embodiments of the invention are not limited to any one or a combination of software, firmware, hardware, or circuitry.

Instructions executed by the computer may be stored in and/or carried through one or more computer readable-media from which a computer reads information. Computer-readable media may be magnetic medium such as, a floppy disk, a hard disk, a zip-drive cartridge, etc.; optical medium such as a CD-ROM, a CD-RAM, etc.; memory chips, such as RAM, ROM, EPROM (Erasable Programmable ROM), EEPROM (Electrically Erasable Programmable ROM), etc. Computer-readable media may also be coaxial cables, copper wire, fiber optics, capacitive or inductive coupling, etc.

In the foregoing specification, the invention has been described with reference to specific embodiments thereof. However, it will be evident that various modifications and changes may be made thereto without departing from the broader spirit and scope of the invention. Accordingly, the specification and drawings are to be regarded as illustrative rather than as restrictive.

What is claimed is:

1. A method for managing data, comprising:
providing main memory of a computer system and a data store as part of the main memory;
providing a storage device associated with the computer system; an access time to the storage device is longer than that of the main memory;
when first data is about to be swapped out of the main memory, determining whether the first data is a good fit for the data store, and, if so, then storing the first data in the data store, and, if not, then storing the first data in the storage device; and
bringing second data to the main memory from one or a combination of the data store and the storage device.

2. The method of claim 1 wherein determining uses one or a combination of compressibility of the first data, desire for access of the first data, history of the first data related to compressibility of the first data and desire for access of the first data.

3. The method of claim 1 wherein an application owning the first data, when requesting memory, provides hints to be used in determining whether the first data is a good fit for the data store.

4. The method of claim 1 wherein a paging manager, based on hints provided by an application owning the first data, determines whether the first data is a good fit for the data store; and data is brought from and to the main memory in a unit of a page.

5. The method of claim 1 wherein:
a size of the data store varies as data is stored in and/or evicted out of the data store; and
as the size of the data store increases, a size of the main memory decreases, and, as the size of the data store decreases, the size of the main memory increases.

6. The method of claim 1 wherein determining whether the first data is a good fit for the data store is based on compressibility of the first data and compressibility of data being stored in the data store.

7. The method of claim 6 wherein determining is further based on one or a combination of nature of an operating system and/or application running on the computer system and desire for access of the first data.

8. A computing system comprising:
main memory having a first access time;
a storage device having a second access time that is slower than the first access time;
a data store having a third access time that is faster than the second access time; and
a paging manager;
wherein when data is about to be moved out of the main memory, the paging manager, based on compressibility of the data, determines whether the data is to be stored in the storage device or the data store.

9. The computing system of claim 8 wherein the paging manager's determination is further based on desire for access of the data.

10. The computing system of claim 8 wherein compressibility of the data is provided by an application using the data.

11. The computing system of claim 8 wherein compressibility of the data is determined based on results of compressing the data and/or on past history of compressing the data.

12. The computing system of claim 8 wherein determining is further based on one or a combination of compressibility of data being stored in the data store and nature of an operating system and/or application running on the computing system.

13. A computer-readable medium embodying computer instructions for implementing a method that comprises:
providing main memory having a first access time;
providing a storage device having a second access time that is slower than the first access time;
providing a data store having a third access time that is faster than the second access time;
wherein when data is about is be moved out of the main memory, performing, in parallel, the following:
storing the data in the storage device;
compressing the data and, based on results of compressing, determining whether the data is a good fit for the data store; and, if so, storing the compressed data in the data store.

14. The medium of claim 13 wherein determining is further based on compressibility of data that is being stored in the data store at time of storing the compressed data in the data store.
